(19) United States
(12) Patent Application Publication
(10) Pub. No.: US 2012/0263424 A1
(43) Pub. Date: Oct. 18, 2012

(54) MULTI-FUNCTION OPTICAL FIBER JUMPER BOX

(76) Inventor: Hsin Lee, Issaguah, WA (US)

(21) Appl. No.: 13/277,647

(22) Filed: Oct. 20, 2011

(30) Foreign Application Priority Data
Apr. 13, 2011 (TW) 100206419

(51) Int. Cl. G02B 6/46

(52) U.S. Cl. 385/135

(57) ABSTRACT

The present invention provides a multi-function optical fiber jumper box, and more particularly a jumper box of a jumper device that serves as a relay jumper coupling for optical fiber signal transmission, which is provided with functions including visual signal inspection and jumper cable protection. The jumper box is mainly structured from transparent plates, the interior of which is partitioned by way of partitioning plates forming a power input pin contact hole and a power output pin contact hole. A rear side of the jumper box forms an open cable wrap end, which enables wrapping round and coupling of a cable, and a light beam transmitted by the jumper cable undergoes a din effect on the outer surface of the plates to enable external inspection of the signal conducting state; moreover, protection is provided against excessive bending of the optical fiber.

### BACKGROUND OF THE INVENTION

(a) Field of the Invention

The present invention provides a multi-function optical fiber jumper box, and more particularly provides signal transmission of two optical fibers, with a jumper box of a relay jumper device enabling through connection of free ends, optical inspection and mechanical protection, as well as structural strength and dustproof effectiveness.

(b) Description of the Prior Art

Jumper devices for optical fiber signal transfer use must be fitted with a coupling unit 1 (as depicted in FIGS. 1˜2), which is used for coupling. In which the coupling unit 1 comprises two groups, a rear end serially connects to an optical jumper cable 20, while the front end is fitted with coupling ends to enable coupling to external optical fibers. A general jumper device is assembled inside an optical-electric box of a system, and is insertedly connected in the same way as a plug. The jumper device primarily enables achieving the objective of coupling ends of two optical fibers in a circuit serving as a signal light beam jumper coupling, as well as further enabling inspecting whether the signal has been transmitted or not. The general coupling unit 1 must be configured into two groups, which respectively pass through cylindrical bodies 10, the front ends of which are respectively fitted with a coupling end 12 and a through mount hole 11. The axes of the through mount holes 11 penetrate rearward and enable bridging of the optical jumper cable 20.

An entering light beam from the coupling ends 12 is thus able to be transmitted out from another rear end after passing through the jumper cable 20. Because the optical jumper cable 20 is designed to be provided with reflection loss, thus, the radial surface of the jumper cable 20 is able to emit a dim light, which enables inspection of a halation. Hence, based on the halation, we can understand whether a power input optical fiber 21 is transmitting a signal or not, thereby enabling maintenance inspection or testing inspection. The periphery of the traditional coupling unit 1 is disposedly mounted in a juxtaposed casing 100, thereby enabling the two groups of the coupling unit 1 to be arranged in parallel juxtaposition. The outer surface of the juxtaposed casing 100 serves as an operation surface, which enables the fingers of a worker to pinch and hold for insertion/extraction use.

Referring again to FIG. 1, which shows the optical jumper cable 20 exposed, thus, in order to prevent the optical jumper cable 20 from being damaged by an external force, the rear end of the juxtaposed casing 100 is fitted with a protective cover, as depicted in FIG. 2, A general protective cover of the prior art is non-transparent, and after inspection from the exterior of the prior art depicted in FIG. 1, because no consideration is given to providing the rear end cover of the juxtaposed casing 100 with a transparent function, thus, if a signal is conducting, then the prior art does not enable the system to produce light mixing, and the rear cover cuts out the light. Hence, although the aforementioned design provides an inspection function, however, mechanical protection of the coupling unit 1 must come from covering by the rear cover, and, structurally, the components are complex. Moreover, during insertion/extraction operations, the rear cover is frequently first pulled, thereby causing the rear cover to fall off, resulting in often losing the rear cover.

### SUMMARY OF THE INVENTION

A primary objective of the present invention is to provide a passive coupling unit that enables direct signal inspection from the exterior of the entire unit. An integral box providing a mechanical protective function enables pin connecting the coupling unit and jumping of a signal. Mutually facing transparent upper and lower plates are longitudinally separated using ribbed partitioning plates provided with a yield opening fitted therebetween to form a box having a “H” shaped cross-section. Two sides of the ribbed partitioning plates respectively form a power input pin contact hole and a power output pin contact hole, which enable the coupling unit set to be insertedly connected therein, and the optical jumper cable series connected to the coupling unit set is able to wrap round and be disposed in the yield opening of the ribbed partitioning plates. Regarding the tested carrying capacity of the light beam, under the condition that the quantity and wave length can be seen, a portion undergoes a refraction effect from the radial surface of the optical jumper cable and is then reflected to the surface of the box. Moreover, the interlayer between the rear ends of the upper and lower plates provides mechanical protection to the jumper cable.

A second objective of the present invention lies in the yield opening at the rear ends of the ribbed partitioning plates obliquely gradually expanding outward to form sloping sides, thereby enabling optical jumper cables of different cable diameter to be pressed and cross mounted therein. The sloping sides can also be of wave form, whereby the wave crests of the wave forms enables clamping the radial curved surface of the optical jumper cable.

A third objective of the present invention lies in the outer surfaces of the upper and lower plates serving as operation surfaces. The operation surfaces are provided with an anti-slip face of wave form. Angular position variation of the wave form is used to enable a light beam to produce refraction at different angular positions, thereby facilitating explicit inspection of the transmission state of the internal light beam at anytime by the user from multi-angular positions.

A fourth objective of the present invention lies in the power input pin contact hole and the power output pin contact hole defined in the jumper box, which are formed by the two side surfaces of the ribbed partitioning plates and the inner surfaces of the upper plate and the lower plate corresponding thereto. The spaces of the power input pin contact hole and the power output pin contact hole formed between the upper plate and the lower plate are provided with side clasp teeth and stop teeth, thereby enabling limiting and fixing position of the coupling unit after insertion in to the jumper box.

A fifth objective of the present invention lies in the inner surfaces of the power input pin contact hole and the power output pin contact hole being provided with rows of teeth, thereby enabling adjustment of the depth the coupling unit can be inserted, and enabling the trailing jumper cable to be pressed in the yield opening and position thereof to be fixed and held firmly therein.

A sixth objective of the present invention lies in a cable wrap opening end of the jumper box, which is additionally fitted with a rear surround plate, thereby achieving a dust-sealing function.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a schematic view of a coupling unit using a juxtaposed casing to achieve providing a jumper device of the prior art.

FIG. 2 is a schematic view depicting a follow-up of FIG. 1 after joining with a rear cover.

FIG. 3 is an elevational perspective view of the present invention.

FIG. 4 is a side view of the present invention.

FIG. 5 is a front view of the present invention.

FIG. 6 is a schematic view depicting the periphery of a coupling unit provided with grip lines according to the present invention.

FIG. 7 is a schematic view depicting assembly of the coupling unit of the present invention.

FIG. 8 is a side view depicting assembly of the coupling unit of the present invention.

FIG. 9 is a schematic view depicting function of a yield opening of the present invention.

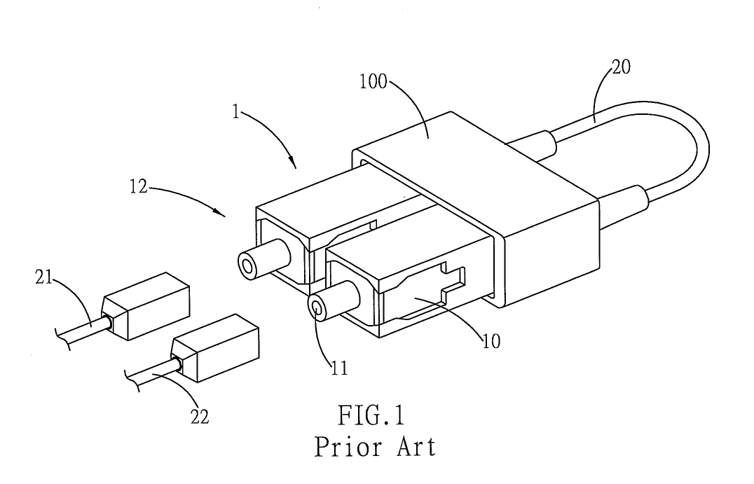

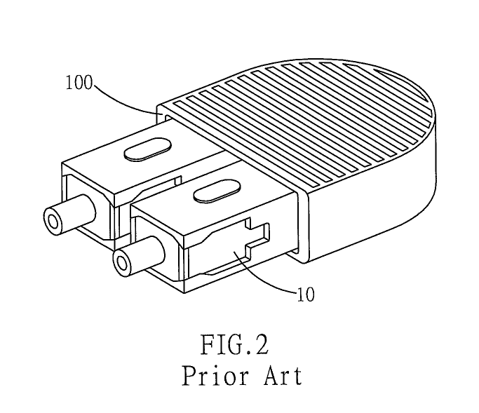

### DETAILED DESCRIPTION OF THE PREFERRED EMBODIMENTS

The present invention provides a jumper box of a jumper device that serves as a relay jumper coupling for optical fiber signal transmission, and is provided with functions including mechanical protection, direct inspection from the exterior and dustproof. In addition, integral linkage of insertion and extraction operations provides convenient operation.

Regarding the detailed structure and operating mode of the present invention, the following provides a description of the referenced figures:

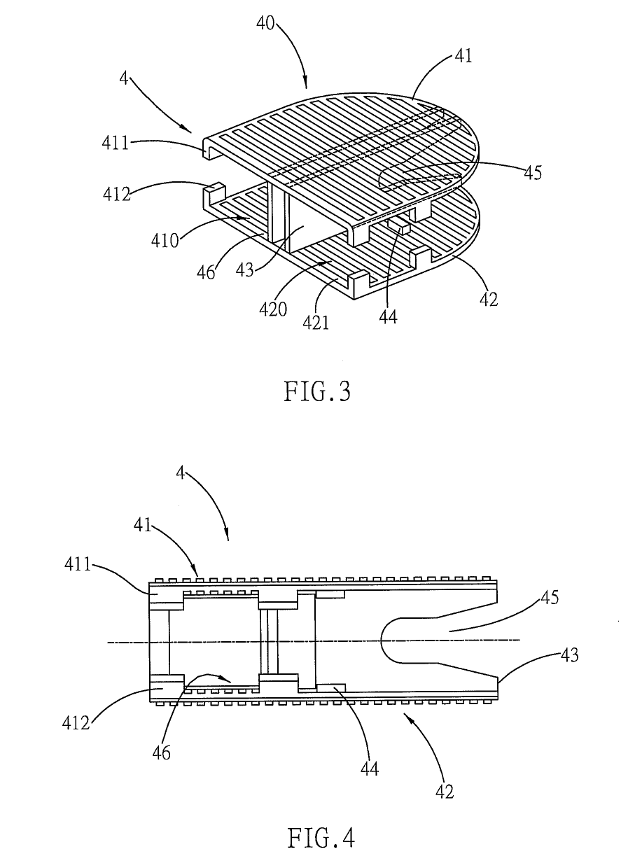

Referring first to FIGS. 3˜5, which show a jumper box 4 of the present invention comprising a transparent upper plate 41 facing a lower plate 42 of equal area and shape, the two plates 41, 42 being longitudinally separated and connected by means of a rectangular ribbed partitioning plate 43 provided with an opening 45 and located between the two plates 41, 42. Such a configuration enables the front end of the jumper box 4 to form a “H” shaped cross-section.

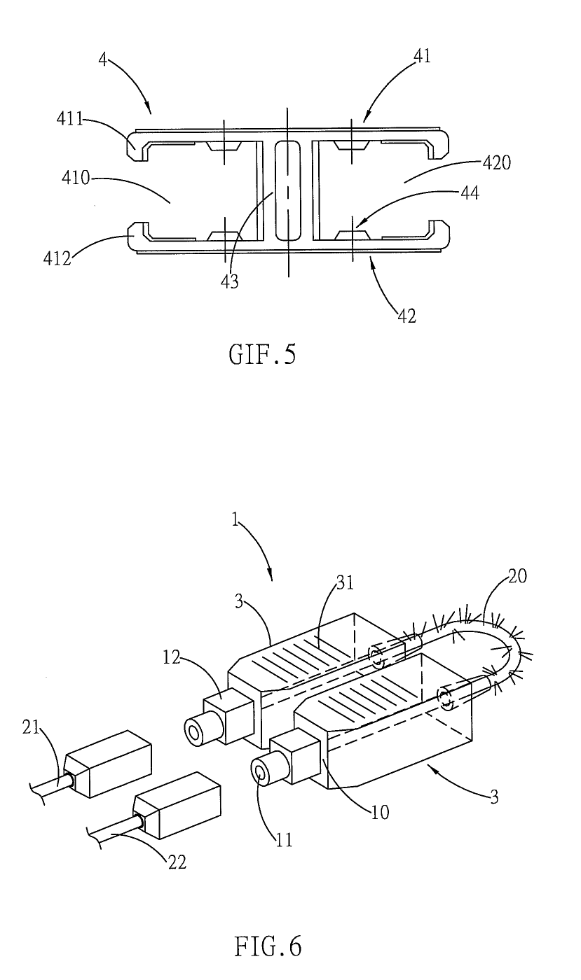

The two sides of the ribbed partitioning plate 43 and between the inner surfaces of the upper plate 41 and the lower plate 42 channel out a power input pin contact hole 410 and a power output pin contact hole 420, which enable a coupling unit 1 to be disposed therein, as depicted in FIG. 6. In addition, two sides of the front sides of the upper plate 41 and the lower plate 42 are provided with side clasp teeth 411, 412 respectively, which inwardly extend into the power input pin contact hole 410 and the power output pin contact hole 420 formed as described above, thereby defining the range of the lateral spaces of the power input pin contact hole 410 and the power output pin contact hole 420. Moreover, stop teeth 44 are located on the inner surfaces of the upper plate 41 or the lower plate 42 to limit depth positions of the power input pin contact hole 410 and the power output pin contact hole 420, thereby defining the depth range of the power input pin contact hole 410 or the power output pin contact hole 420. Furthermore, the stop teeth 44 may be located on the two sides of the ribbed partitioning plate 43, thereby similarly achieving limiting the depth of the power input pin contact hole 410 or the power output pin contact hole 420.

In the jumper box 4 formed as described above, the exterior is an operation surface 40, and the operation surface 40 is a frictional anti-slip surface or a flexible anti-slip surface. Furthermore, the operation surface 40 can be an undulated anti-slip surface. The surface of each undulation of the undulated anti-slip surface forms a different refraction angle. At any angular position at the front or rear of a transverse undulation, the user has the opportunity for multi-angular views to view the light beam reflected and transmitted out by the internal point light source, enabling inspection by the user from the outside.

The aforementioned connective relationship between the upper plate 41, the lower plate 42 and the ribbed partitioning plate 43 can be achieved by adopting a method that enables the connective relationship to be formed as an integral body. Moreover, the ribbed partitioning plate 43 can use two separate facing pieces, thereby increasing horizontal mechanical strength. The internal spaces of the power input pin contact hole 410 and the power output pin contact hole 420 are further provided with a position fixing configuration, such as rows of teeth 46. The rows of teeth 46 are transverse relative to the longitudinal depth of the power input pin contact hole 410 or the power output pin contact hole 420, thereby enabling adjustment of the depth in front of the stop teeth 44. The rows of teeth 46 are configured to correspond to transverse grip lines 31 provided on the surface of interconnecting coverings 3 (as depicted in FIG. 6).

Referring again to FIG. 6 (in conjunction with FIG. 3), the coupling unit 1 of the present invention comprises the interconnecting coverings 3 and cylindrical bodies 10 internally provided therein. As a minimum, the exterior of the main bodies is provided with the grip lines 31, and the grip lines 31 correspond to the rows of teeth 46 depicted in FIG. 3 and FIG. 4. When the coupling unit 1 is respectively disposed into the power input pin contact hole 410 and the power output pin contact hole 420, the longitudinal depth of the coupling unit 1 can be adjusted before reaching maximum insertion. The objective of adjusting is to enable pulling the optical jumper cable 20 close to a pressing position of a yield opening 45 when the optical jumper cable 20 is relatively long, thereby enabling the body of the optical jumper cable 20 to be clamped and position fixed therein.

The front end of the coupling unit 1 is fitted with coupling ends 12 and through mount holes 11, which enable a power input optical fiber 21 and a power output optical fiber 22 to be respectively coupled thereto. After a light beam transmitted by the power input optical fiber 21 or the power output optical fiber 22 passes through the coupling unit 1, then the light beam is conducted to the optical jumper cable 20. Because the optical jumper cable 20 is provided with partial reflection loss, thus, its radial surface is able to emit a dim light beam. The dim light beam is then able to serve as an inspection light source to determine whether the optical jumper cable 20 is conducting a light beam or not.

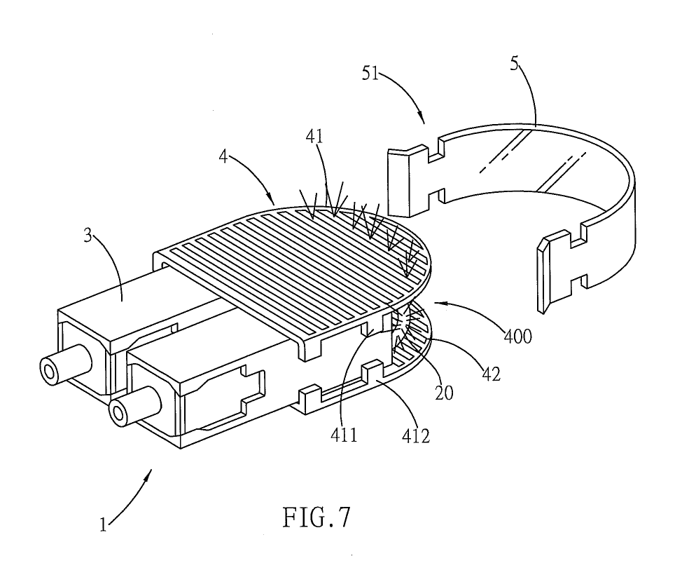

Referring to FIG. 7, after the coupling unit 1 is assembled to the jumper box 4, then the optical jumper cable 20 is wrapped round inside a semi-open cable wrap opening 400 at the rear end of the jumper box 4, thereby enabling protection of the optical jumper cable 20 by the tail sides of the upper plate 41 and the lower plate 42 of the jumper box 4. Because the upper plate 41 or the lower plate 42 is transparent, thus, a portion of the light beam passing through the optical jumper cable 20 can emit refracted light at the area of the cable wrap opening 400. The user is able to see through the plate surface of the upper plate 41 or the lower plate 42 and inspect whether the optical jumper cable 20 is conducting a light beam or not, or because of the lateral opening of the cable wrap opening 400, thus, inspection from a lateral angle of view can also be obtained.

When applying the aforementioned semi-sealed mechanical protection in a system, in order to avoid visual interference of directly seeing the light beam emitted from the optical jumper cable 20 from the rear side, a non-transparent rear surround plate 5 can be used to cover the external periphery of the cable wrap opening 400. The covering method uses clasp portions 51 provided at the front ends of the two sides of the rear surround plate 5 to clasp onto the positions of side clasp teeth 411, 412 of the upper plate 41 and the lower plate 42 respectively, thereby forming a mechanical clasping connection. A frictional press and clasp method can also be used, thereby also enabling the rear surround plate 5 to be assembled to the side of the cable wrap opening 400.

The principle behind the peripheral mechanical protection of the optical jumper cable 20 is to use covering by the rear surround plate 5 to achieve dustproof and waterproof sealing effectiveness, and in order for the user to enable to directly see through the rear end of the jumper box 4 and inspect conductance of a light beam, thus, the rear surround plate 5 is provided as a transparent body.

In the jumper box 4 of the present invention (see FIG. 3 and FIG. 6), the upper plate 41 is at least provided with a refraction function, moreover, the interlayer between the upper plate 41 and the lower plate 42 forms the power output pin contact hole 420 and the power input pin contact hole 410, which enable the interconnecting coverings 3 to be respectively disposedly clasped therein. Furthermore, in actual use, the outer body of the interconnecting coverings 3 of the coupling unit 1 is provided with different colors for visual identification according to the optical signal type transmitted through the coupling unit 1. For example, transmission of a single mode optical signal is usually set as a blue color, multi-mode optical signal is a black color, and so on. Accordingly, after the interconnecting coverings 3 are disposed within the jumper box 4 of the present invention, at least one surface enables providing a refraction function. The reflected light from the outer body of the internally disposed interconnecting coverings 3 passes through the upper plate 41 of the jumper box 4, and colored light is refracted outward, thereby enabling the user to directly inspect the light from the exterior of the jumper box 4 and know the type of light being transmitted by the coupling unit 1. Correspondingly, the configuration of the jumper box 4 of the present invention can be used to couple to the coupling unit 1 providing any mode of optical transmission, In other words, a configuration having a single specification as described in the present invention can be used to function in conjunction with any coupling unit 1. Hence a 100% use factor is achieved regarding preparing of materials for production. Moreover, the configuration completely satisfies the user regarding the time required for replacement or maintenance.

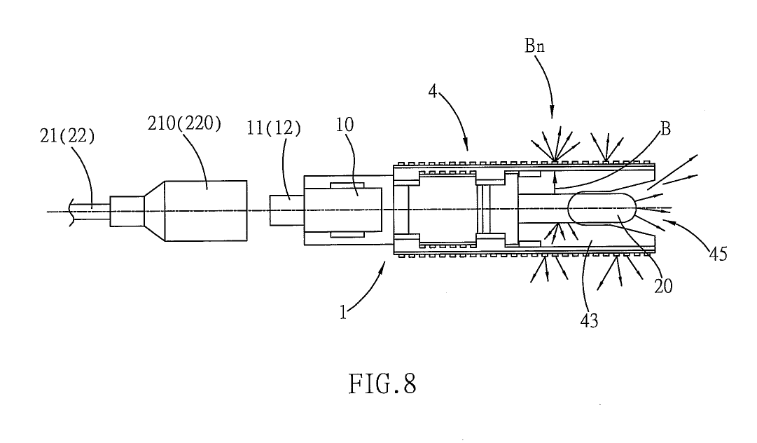

Referring to FIG. 8, the jumper box 4 of the present invention enables the coupling unit 1 to penetrate and be insertedly connected therein. The optical jumper cable 20 wound round the rear end of the coupling unit 1 wraps round the yield opening 45 of the ribbed partitioning plates 43, thereby causing the external end at the highest point of the curved optical jumper cable 20 to be retained within the depth range of the yield opening 45. Accordingly, the jumper box 4 is able to provide semi-open type protection to the coupling unit 1, and the through mount holes 11 of the coupling unit 1 enable a coupling connector 210 and a coupling connector 220 fitted to the power input optical fiber cable 21 and the power output optical fiber cable 22 respectively to be coupled thereto.

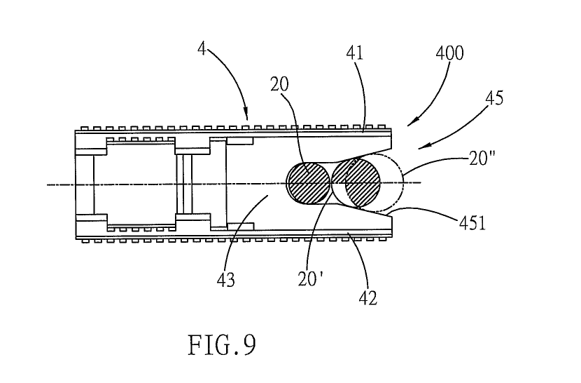

Referring to FIG. 9, the yield opening 45 provided by the ribbed partitioning plates 43 obliquely gradually opens outwardly towards the rear end of the jumper box 4, and forms the cable wrap opening 400 between the upper plate 41 and the lower plate 42. The shape of the cable wrap opening 400 forms a symmetrical “ V” shaped opening, which enables the optical jumper cable 20 (20′ or 20″) of different cable diameter to be clamped therein. The shape of symmetrical sloping sides 451 of the “V” shape can be of wave form. The wave form uses different positioned wave crests (not shown in the drawings) to accommodate the optical jumper cable 20 of different cable diameter and radially clamp the curved surface, thereby mechanically fixing position of the optical jumper cable 20. A final situation comprises the optical jumper cable 20 being disposedly placed at the bottom portion of the coupling unit 1, with the cable diameter of the optical jumper cable 20 being smaller than the width of the yield opening 45.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A multi-function optical fiber jumper box, providing a jumper box of a jumper device that serves as a relay jumper coupling for optical fiber signal transmission, comprising:
a transparent upper plate;
a lower plate having area and shape corresponding to the upper plate;
a ribbed partitioning plate of rectangular area provided with a yield opening at the rear end thereof, and which is vertically joined between the mutually facing inner surfaces of the upper plate and the lower plate at a longitudinal center thereof, thereby structuring the jumper box; an interior of the rear end of the jumper box uses the yield opening to channel out a semi-open cable wrap opening; a power input pin contact hole and a power output pin contact hole are respectively channelled out between the inner surfaces of the upper plate and the lower plate at two sides of the ribbed partitioning plates.

2. The multi-function optical fiber jumper box according to claim 1, wherein the lower plate is transparent.

3. The multi-function optical fiber jumper box according to claim 1, wherein the outer surface of the cable wrap opening at the rear end of the jumper box is additionally fitted with a rear surround plate.

4. The multi-function optical fiber jumper box according to claim 3, wherein the rear surround plate is transparent.

5. The multi-function optical fiber jumper box according to claim 1, wherein two sides of the upper plate are internally provided with side clasp teeth.

6. The multi-function optical fiber jumper box according to claim 1, wherein two sides of the lower plate are internally provided with side clasp teeth.

7. The multi-function optical fiber jumper box according to claim 1, wherein the inner surface of the upper plate is provided with stop teeth, which define longitudinal depths of the power input pin contact hole and the power output pin contact hole.

8. The multi-function optical fiber jumper box according to claim 1, wherein the inner surface of the lower plate is provided with stop teeth, which define longitudinal depths of the power input pin contact hole and the power output pin contact hole.

9. The multi-function optical fiber jumper box according to claim 1, wherein two sides of the ribbed partitioning plate are respectively provided with stop teeth, thereby defining longitudinal depths of the power input pin contact hole and the power output pin contact hole.

10. The multi-function optical fiber jumper box according to claim 1, wherein the pin contact holes are provided with a plurality of rows of teeth transversally arranged from front to rear within the longitudinal depth range of the pin contact holes, thereby enabling one by one clasping of grip lines provided on outer surfaces of interconnecting coverings thereon.

11. The multi-function optical fiber jumper box according to claim 1, wherein the yield opening obliquely expands outwardly thereby defining oblique sides.

12. The multi-function optical fiber jumper box according to claim 11, wherein the oblique sides of the yield opening are of curved wave form.

13. The multi-function optical fiber jumper box according to claim 1, wherein the outer surfaces of the the upper plate and the lower plate are provided with anti-slip operation surfaces.

14. The multi-function optical fiber jumper box according to claim 13, wherein the operation surfaces are provided with waveform surfaces of different refraction angle.
